(19) United States
(12) Patent Application Publication
(10) Pub. No.: US 2006/0175488 A1
(43) Pub. Date: Aug. 10, 2006

(54) Holding device for a brushing fluid application tool

(76) Inventors: Jochen Schmiddem, Berlin (DE); Tilo Keiner, Berlin (DE)

Correspondence Address: NIXON & VANDERHYE, PC, 901 NORTH GLEBE ROAD, 11TH FLOOR, ARLINGTON, VA, 22203, US

(21) Appl. No.: 10/547,423

(22) PCT Filed: Mar. 1, 2004
(86) PCT No.: PCT/EP04/02051

§ 371 Date: Mar. 2, 2006

(51) Int. Cl. B44D 3/12

(52) U.S. Cl. 248/213.2; 248/302

(57) ABSTRACT

The present invention is a holding device for fixing, for example, a fluid application tool to a container. The holding device has a clamping element for clamping a tool to the container edge and a system for the reception thereof. The holding device may be used to fix a tool to containers of varying sizes. For this purpose, a reception system having an elongated clamp arranged on a clamping system is provided with a concave support on the free end thereof, which is spaced from the clamping system and is designed for a handle or holder of the application tool. To support an application tool, a shackle is outwardly protruded with respect to the clamping system and the container, thereby forming a double support together with a support surface formed on the clamping system. To obtain a suspension fixation for the application tool, the elongated clamp is extended above the clamping system and the container in a substantially vertical manner.

The invention relates to a holding device for an application tool, in particular brushes or rollers, for liquid coating products such as paint or wallpaper paste, on a coating product container, in particular a bucket.

Holding devices for brushes and paint rollers are known which hold the application tool in question if there is a short interruption in coating activity. DE 87 12 535 U1 thus describes a brush holder for holding painting tools (application tools) such as brushes, surface coaters and rollers which can be positioned on the edge of open paint containers (coating product containers) such as paint pots or paint buckets, and it makes it possible to set down the application tool in question. This brush holder has a clamping device for the edge of the coating product container and two clamp side pieces positioned on this which are both designed in a double S-shape for holding application tools. The clamp side pieces are positioned on the outer side of the coating product container and project out from this so that the application tools are held clamped in a tangential position and so that any paint or other coating product on the application tools drips off outside of the container and not back into the container. For reasons relating to space, the brush holder is largely unsuitable for the positioning of application tools in the opening of the coating product container.

The subject matter of DE 100 12 031 A1 is a brush holder for coating product containers which has a clamp bracket for fastening onto the coating product container, and at least one clamping device for brushes, the latter being designed such that the brush is held in an inclined position in such a way that any liquid coating product still adhering to the same can drip off into the coating product container. In this way, the brush handle remains largely free from coating product. The clamping device for the brush has a cross-piece which extends at right angles to the edge of the coating product container and extends essentially horizontally over this, and on which two holders, spaced apart, are located for at least one brush, of which the outer holder is positioned in the area outside of the coating product container, and holds the respective handle at a greater distance from the cross-piece than the inner one so that the brush can be held diagonally downwards and with its bristles towards the middle of the container. Any coating product remaining in the brush then drips off into the coating product container. The brush holder is relatively complex.

In addition, DE 87 12 532 U1 describes a holder for holding painting tools such as brushes, surfaces coaters and rollers (application tools), which has a rectangular, U-shaped bar, the lower end sections of which, for attachment, are provided with slit-shaped cut-outs on the edge of the open side of a coating product container, and on the outer sides of which there are holders of a different types for holding the application tools. The holders can be designed as hook-shaped holders or as clamping members, and are connected to the U-shaped bar by means of adhesive or screw joints. On the upper end section of the bar there is a cut-out which serves in particular for holding and fixing a paint roller which can be hung by its shaft in the cut-out so that it projects into the paint bucket, but is not immersed in the paint. This holder is also technologically complex, and in addition, material-intensive.

Furthermore, DE 297 04 163 U1 makes known a container attachment for open liquid containers, in particular tins of paint, which has an annular base section which can be placed on the open liquid container to form a seal, with a pour-out channel and a brush rest. The brush rest is formed from a cross-piece in front of the pour-out channel over the opening of the container and a set-down plate formed on the side opposite the pour-out channel on the periphery of the base section. The set down brush lies in a two-point support on the set-down plate and the cross-piece diagonally over the opening, and slightly inclined downwards on the base section. The container attachment is unsuitable for containers larger than tins of paint because it is too complex and the cross-piece and set-down plate would lie too far apart for brushes of standard length. A cross-piece positioned nearer to the set-down plate would also prevent access to the coating product within the container. Moreover, the base section must be adapted to the diameter of the container.

It is the object of the invention to design a holding device for an application tool for liquid coating products on a coating product container according to the preamble to claim 1 such that this is of simple construction and largely independent of the size of the coating product container.

This object is fulfilled for a coating product container according to the preamble to claim 1 by means of the characterising features of the same. Advantageous embodiments are defined in the subclaims.

The invention consists of a holding device for an application tool for liquid coating products which is formed from a clamping device and an accommodating device, the clamping device being attachable to the edge of a coating product container, and the accommodating device holding the application tool. The accommodating device here is formed by an elongated bracket located on the clamping device, said bracket having a concavely bent support for the handle or shaft of the application tool at its free end, spaced apart from the clamping device, and this makes it possible for the handle or shaft to be set down or hung up.

In order to set down an application tool, the bracket is positioned on the clamping device in such a way that the bracket projects at right angles (radially) from the clamping device, and so also from the coating product holder, and forms a two-point support for the application tool with a set-down surface provided on the clamping device. The application tool which has been set down thus lies with its handle or shaft at right angles over the edge of the coating product container, and with its brush head within this edge over the liquid coating product so that any coating product still on the brush can drip off into the coating product container. This gives a holding device which is of simple design, with which in particular painting tools can be temporarily set down on paint buckets, cleanly and visibly. Because the bracket on the respective coating product container projects out, and only the brush head projects over the opening of the same, the holding device can be used basically independently of the size of the coating product container. Only the size of the brush head requires a minimum size for this. The form of the coating product container is of no importance for use of the holding device.

In a preferred embodiment, the bracket is made from steel wire and in its longitudinal direction it has two side pieces, spaced apart from one another, and essentially parallel to one another, on which at one end the clamping device is positioned or formed in one part, and which, at the other end, are connected to one another by the support.

Here, the bracket for setting down an application tool in the area of the clamping device connected to this, consisting of a part formed in a U-shape, the side pieces of which can overlap the edge of the container in an essentially form-locking manner, and inclined towards one another, can be bent downwards, and with the free ends of its side pieces on the outer side, and spaced apart from the clamping device, lie under this on the coating product container in such a way that the outer clamping side piece of the clamping device is elongated. A design of this type makes it possible to increase the clamping tension and serves to securely attach the holding device on the edge of the coating product container in question. In order to increase the effect, the side pieces can be concavely bent in relation to the coating product container. Advantageously, the clamping device is a one-part synthetic injection moulded part which can expand elastically. This is easily manageable. The bracket produced from steel wire, preferably from a steel wire which is 3 to 5 mm thick, is embedded in this clamping element, in particular welded or adhesively bonded.

However, the clamping device can also be moulded onto the bracket. In this case, the bracket is bent downwards on the container side and, in order to form the clamping device, has two essentially meander-shaped 180 degree curves, one after the other, from which the one on the bracket side forms two clamping side pieces which overlap, in an essentially form-locking manner, the edge of the coating product container. For the preferred case whereby the bracket is formed from two wires positioned parallel to one another, the clamping side pieces are each formed from two wires spaced apart from one another. The end portions of these wires thus form the clamping side piece lying against the inner side of the wall of the coating product container. This, or the two wire side pieces forming this can, as in the previously described embodiment, be concavely arched in relation to the wall of the coating product container so as to increase the preliminary tension.

Advantageously, the bracket is inclined towards the inside of the container so that any coating material remaining on the brush runs towards the head of the brush, and here, drips off into the coating product container. In this way, any coating product remaining on the tool is prevented from running down the handle or shaft, and from dripping out of the coating product container. In addition, the bracket is designed so that a straight line connecting the concave support with the setting-down surface on the clamping device adopts an angle of between 5 and 15 degrees in relation to the level determined by the edge of the coating product container.

An alternative to the bracket arrangement on the clamping device described above is the bracket with the concavely bent support for holding an application tool in a hanging position over the coating product, extending essentially vertically over the clamping device and the coating product container. Here, the clamping device, as with the embodiment described above, is either a U-shaped, elastically expandable synthetic element which is embedded into the bracket, in particular welded or adhesively bonded, or is moulded onto the bracket. With this holding device, the bracket lies against the inside of the coating product container, preferably spaced apart from the clamping element and beneath the same, so that the application tool, for example a paint roller, to be held hangs over the inside of the container. Here, the vertically positioned bracket can easily be inclined towards the middle of the container.

In the following the invention is explained using examples of embodiments. In the associated drawings:

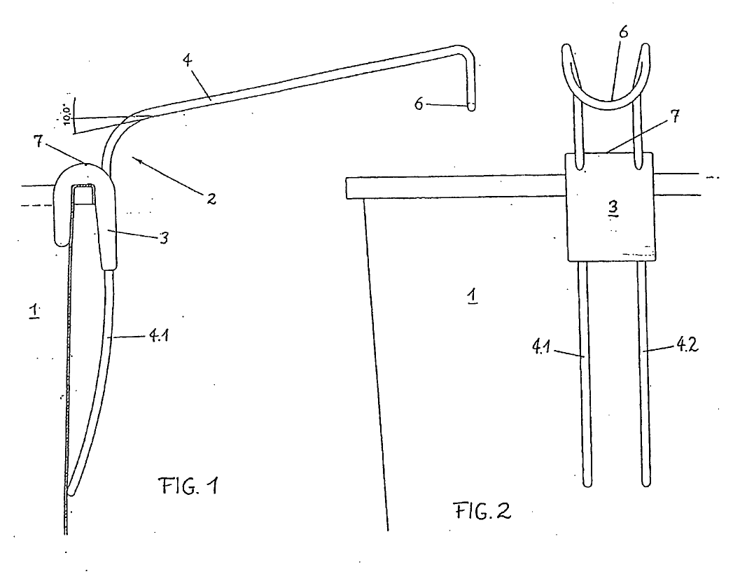

FIG. 1: shows a side view of a holding device positioned on a coating product container,

FIG. 2: shows a view of the outer side of the coating product container with the holding device,

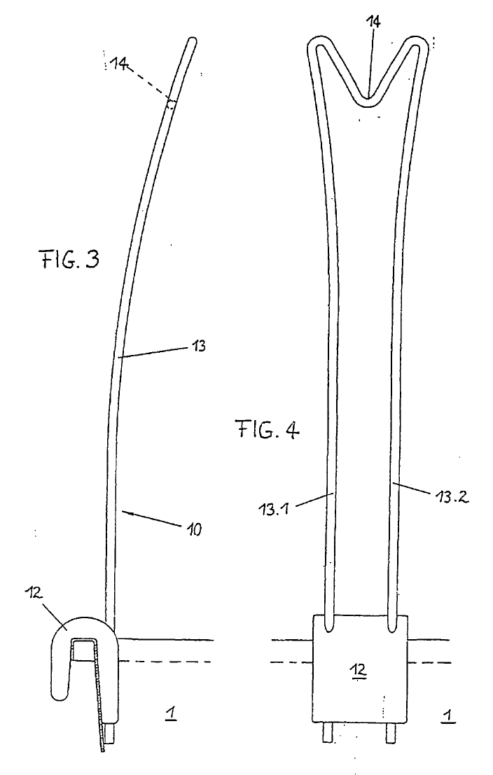

FIG. 3: shows a side view of another holding device positioned on a coating product container,

FIG. 4: shows a view of the outer side of the coating product container with this holding device,

FIG. 5: shows a perspective view of an alternative holding device to the holding device according to FIGS. 1 and 2,

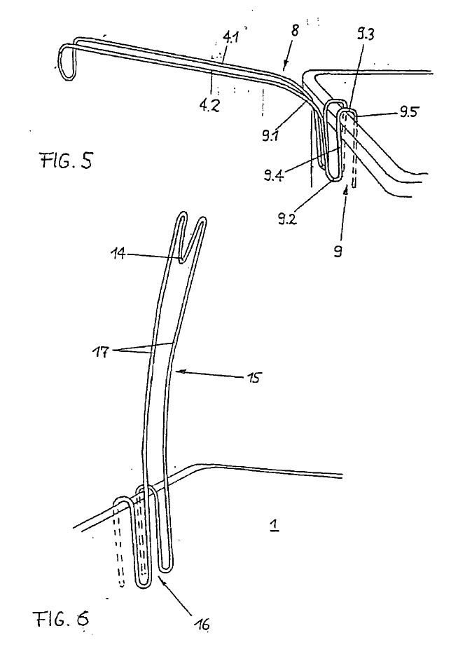

FIG. 6: shows a perspective view of an alternative holding device to the holding device according to FIGS. 3 and 4,

FIG. 7: shows a holding device according to FIG. 1 with a paint roller being held, and

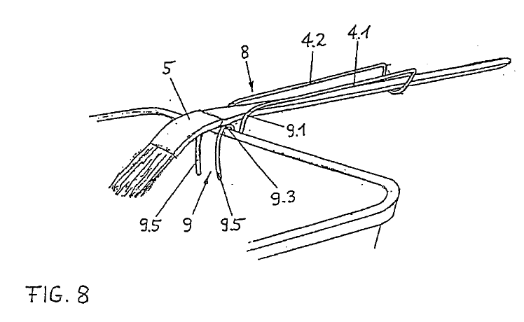

FIG. 8: shows a holding device according to FIG. 5 with a paint brush which has been set down.

The holding device 2 shown in two views in FIGS. 1 and 2 and securely clamped onto the edge of a paint bucket 1 (eg. LUX-bucket or Universal paint bucket) has an elastically expandable U-shaped clamping element 3 made from PE (alternatively PUR) for the edge of the paint bucket 1, and a wire bracket 4 welded into the clamping element 3 which projects outwards from the clamping element 3 and so also from the paint bucket 1 such that a brush (5, FIG. 8) can be set down. The clamping element 3 has a material thickness of essentially 6 mm, a side piece length of 40 or 50 mm, and is 43 mm wide, its side pieces overlapping the edge of the paint bucket 1 in an essentially form-locking manner. The wire bracket 4 is bent from 4 mm thick steel wire and formed from two side pieces 4.1 and 4.2 spaced apart from one another (clearance 33 mm) and positioned essentially parallel to one another, which are welded onto the clamping element 3 on the container side, and which on the end facing away from this form a support 6 bent in a U-shape (concavely) for the brush (5). The wire bracket 4 is bent downwards on the clamping element 3, taken through the clamping element 3, and lies with the free ends of its two side pieces 4.1 and 4.2 on the outer side, and at a distance of 100 mm from the paint bucket 1. This design makes possible a simpler arrangement of the holding device on the paint bucket 1 and at the same time serves to increase the clamping force. In addition, the side pieces 4.1 and 4.2 are slightly concavely bent in relation to the paint bucket 1 so as to increase the pretensioning force. It can be seen that the side-pieces 4.1 and 4.2 projecting out from the paint bucket 1 are inclined by 10 degrees in relation to the level determined by the edge of the paint bucket 1 so that a brush (5) which has been set down is inclined towards the inside of the paint bucket 1. In this way, the clamping element 3 forms a setting-down surface 7 for the brush (5) between the side-pieces 4.1 and 4.2. This gives a two-point support for these application tools.

FIG. 8 shows the brush 5 set down on an alternative holding device 8. This holding device 8, which is shown in FIG. 5 in another perspective representation, is different from the holding device 2 because of the clamping device 9. This clamping device 9 is formed as one part with the side-pieces 4.1 and 4.2. In addition, on the container side, these each have first of all a curve 9.1 pointing vertically downwards, and two meander-shaped curves of approx. 180° 9.2 and 9.3, one after other, which form the clamping element 9, the curve 9.3 on the clamp end side in association with the side-pieces 9.4 and 9.5 comprising these forming the actual U-shaped clamping element 9. The side pieces 9.4 and 9.5 are slightly inclined towards one another. In this embodiment, either both of the curves 9.3 or the area of the paint bucket edge between them form a set-down surface for a two-point support for the application tool in question.

In FIGS. 3, 4 and 7 a holding device 10 for holding a paint roller 11 (FIG. 7) in a hanging position over a paint bucket 1 and the liquid paint located therein is shown. This holding device 10 has a clamping element 12 comparable to the clamping element 3, and a wire bracket 13 which extends essentially vertically over this. The two side-pieces 13.1 and 13.2 of the wire bracket 13 are arranged essentially parallel to one another, and are connected to one another at their upper end by means of a V-shaped (concave) support 14 in which the shaft 15 of the paint roller 11 can be hung (supported) (FIG. 7). The support 14 here is formed on the level determined by the side-pieces 13.1 and 13.2. In this embodiment the free (lower) side-piece ends are on the inside and at a small distance (1 cm) from the clamping element 12, under the same, and pre-tensioned on the paint bucket 1. The vertically positioned wire bracket 13 is slightly inclined towards the middle of the paint bucket. The side-pieces are 360 mm in length.

In an alternative embodiment, the holding device 15 has a one-part clamping device 16 formed on the lower ends of the side-pieces which is shown in FIG. 6. As with the holding device 8 according to FIGS. 5 and 8, the clamping device 16 is formed by two 180° curves, one after the other, of the free end portions of the side-pieces. The wire bracket 17 formed vertically on the clamping device 16 is positioned on the inner side of the paint bucket so as to guarantee holding of a paint roller 11 over the liquid paint in the paint bucket 1. In addition, the wire bracket 17 for this is inclined slightly towards the middle of the paint bucket.

### LIST OF REFERENCE NUMBERS

1 Paint bucket
2 Holding device
3 Clamping element
4 Wire bracket
4.1 Side piece
4.2 Side piece
5 Brush
6 Support
7 Set-down surface
8 Holding device
9 Clamping device
9.1 Curve
9.2 180° curve
9.3 180° curve
9.4 Side piece
9.5 Side piece
10 Holding device
11 Paint roller
12 Clamping element
13 Wire bracket
13.1 Side piece
13.2 Side piece
14 Support
15 Shaft
16 Clamping device
17 Wire bracket

1. A holding device for an application tool for liquid coating products on a coating product container comprising a clamping device for the edge of the coating product container and an accommodating device for the application tool, wherein the accommodating device is formed by an elongated bracket positioned on the clamping device, which at its free end, spaced apart from the clamping device, has a concavely bent support for the handle or shaft of the application tool, the bracket projecting outwards from the clamping device and so also from the coating product container so that an application tool can be set down, and forming a two-point support with a set-down surface provided on the clamping device, or the bracket extending essentially vertically over the clamping device and the coating product container so that an application tool can be held in a suspended position over the coating product.

2. The holding device according to claim 1, wherein the bracket is formed from steel wire and has two side pieces spaced apart from one another, and positioned essentially parallel to one another, on which the clamping device is positioned on the container side, or is formed as one part, and which are connected to one another at the end facing away from this by means of the support.

3. The holding device according to claim 2, wherein the bracket is bent down in the area of the clamping device so that an application tool can be set down, and with the free ends of its side pieces on the outside, and spaced apart from the clamping device, lies beneath this, pre-tensioned on the coating product container.

4. The holding device according to claim 3, wherein the side pieces are concavely curved beneath the clamping device opposite the wall of the coating product container.

5. The holding device according to claim 2, wherein the bracket for setting down an application tool is bent downwards on the container side, and has two essentially meander-shaped 180° curves, one after the other, to form the clamping device, from which the one on the side of the end of the bracket forms a clamping element.

6. The holding device according to claim 2, wherein the bracket for holding an application tool in a hanging position lies with the free ends of its side pieces on the inside and spaced apart from the clamping device below the same, pre-tensioned on the coating product container.

7. Holding device according to claim 2, wherein the bracket for holding an application tool in a hanging position has two essentially meander-shaped 180° curves, one after the other, to form the clamping device, from which the one on the side of the end of the bracket forms a clamping element.

8. Holding device according to claim 1, wherein the bracket is inclined towards the inside of the container such that a straight line connecting the concave support on the bracket with the setting-down surface on the clamping device adopts an angle of 5 to 15° in relation to the level determined by the edge of the coating product container.

9. Holding device according to claim 1, wherein the vertically positioned bracket is slightly inclined towards the middle of the container.

10. Holding device according to claim 1, wherein the bracket is made from 3 to 5 mm thick steel wire.

11. Holding device according to claim 1, wherein the positioned clamping device is a U-shaped part, the side pieces of which overlap the edge of the coating product container in an essentially form-locking manner, and are inclined towards one another.

12. Holding device according to claim 1, wherein the clamping device is an elastically expandable synthetic part with which the side pieces of the bracket are securely connected, in particularly welded.
